(19) United States
(12) Patent Application Publication
(10) Pub. No.: US 2008/0172784 A1
(43) Pub. Date: Jul. 24, 2008

(54) BATH MAT BLOWER ASSEMBLY WITH CORD REEL

(76) Inventor: KAM FAI FUNG, Tuen Mun (CN)

Correspondence Address: Lawrence Cruz;Conair Corporation, One Cummings Point Road, STAMFORD, CT, 06902, US

(21) Appl. No.: 12/017,591

(22) Filed: Jan. 22, 2008

Related U.S. Application Data
(60) Provisional application No. 60/881,786, filed on Jan. 22, 2007.

(51) Int. Cl. A61H 33/00; A47K 3/00

(52) U.S. Cl. 4/541.5; 4/559

(57) ABSTRACT

A bath mat blower assembly (1) has a retractable cord reel for efficiently storing a power cord (4) in a bath mat with an electrically driven pump for forcing pressurized air through various conduits to create bubbles that are emitted from a component of the bath mat that is submerged under water in a bathtub

### CROSS-REFERENCE TO RELATED APPLICATIONS

None.

### BACKGROUND OF THE INVENTION

1. Field of the Invention

The present invention relates to personal care appliances and, more particularly, to bath mats of the type that are placed into a bathtub and that provide air bubbles originating from an electrically driven pump.

2. Description of Related Art

Various bath mats exist having an electrically driven pump for forcing pressurized air through various conduits to create bubbles that are emitted from a component of the bath mat that is submerged under water in a bathtub. No known bath mats exist that have a retractable cord reel in the blower assembly for efficiently storing a power cord.

### OBJECTS OF THE PRESENT INVENTION

It is an object of the present invention to provide a bath mat blower assembly having a retractable cord reel for efficiently storing a power cord in a bath mat with an electrically driven pump for forcing pressurized air through various conduits to create bubbles that are emitted from a component of the bath mat that is submerged under water in a bathtub.

These and other objects are achieved by the present invention.

### BRIEF SUMMARY OF THE PRESENT INVENTION

According to the present invention a bath mat blower assembly has a retractable cord reel for efficiently storing a power cord in a bath mat with an electrically driven pump for forcing pressurized air through various conduits to create bubbles that are emitted from a component of the bath mat that is submerged under water in a bathtub.

### BRIEF DESCRIPTION OF THE DRAWINGS

FIG. 1 is a perspective view of a bath mat blower assembly for use with a bath mat.

### DETAILED DESCRIPTION OF THE PREFERRED EMBODIMENT OF THE INVENTION

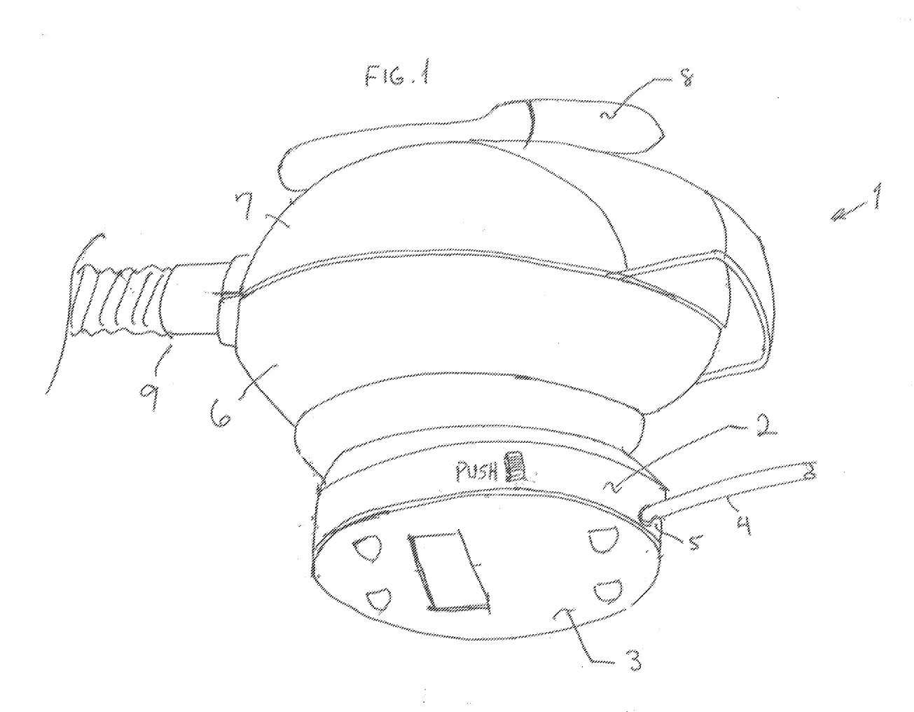

Referring to FIG. 1, a bath mat blower assembly 1 has a base 2, a base bottom 3, a cord 4, a cord opening 5, a lower housing 6, an upper housing 7, a remote control 8 and a hose 9. The base 2 serves to support the assembly 1 as it rests on a generally flat surface. The bottom 3 rests on the generally flat surface and forms the lower part of an internal chamber between the bottom 3 and the lower housing 6 in which conventional components for forming a spring-loaded cord reel of a type generally known for use with appliances (not shown) is located. The cord 4 extends out from the opening 5 and can be retracted with respect thereto, being wound about the cord reel (not shown) in a manner generally known. The cord 4 can be pulled out of the opening and it will lock in that position via ratchet mechanisms of a type generally known (not shown). When it is desired to retract the cord 4, a release button 10 is activated to release the ratchet mechanism and permit the cord 4 to be recoiled under the force of an internal spring (not shown). The cord 4 is a standard power cord and is plugged into an electrical wall socket to provide electrical power to an electric motor and controller in the assembly 1.

The lower housing 6 and the upper housing 7 enclose various conventional components including an electric motor (not shown), an air pump (not show), and various associated controls and mechanisms for selectively generating air under pressure that is blown out through the air hose 9 to a bath mat (not shown) connected thereto for producing air bubbles from a portion of the bath mat that is submerged under water in a bathtub. A remote control 8 is provided to give a user the ability to conveniently and remotely operate the assembly 1 while the assembly 1 is positioned on a surface away from the bathtub. The remote control 8 may be corded, tethered or wireless.

While the preferred embodiment has been disclosed, various modification can be made without departing from the scope of the present invention.

What is claimed is:

1. A housing for a bath mat blower assembly for housing an electrically powered motor and fan adapted to blow air out of said assembly and through a bath mat in order to cause air bubbles to emit from said bath mat when said bath mat is submerged in water, said housing comprising
a main body; and
a cord reel body having an opening through which a section of electrical cord extends from while the remainder of the electrical cord is coiled within the cord reel body.

2. A housing according to claim 1, wherein
said cord reel body comprises a generally flat bottom surface and a generally round wall connected to said bottom surface in a generally orthogonal relationship.

3. A housing according to claim 1, wherein
said main body is attached to and supported by said cord reel body so that said main body is positioned above said cord reel body when said cord reel body is rested directly on a flat surface.

4. A housing according to claim 1, wherein
said main body is adapted to have a hand held remote control releasably mounted thereto.
